(19) United States
(12) Patent Application Publication
(10) Pub. No.: US 2026/0039206 A1
(43) Pub. Date: Feb. 5, 2026

(54) Switching Power Supply

(71) Applicant: Joulwatt Technology Co., Ltd., Hangzhou City (CN)

(72) Inventors: Xiangyong XU, Hangzhou (CN); Changwei GONG, Hangzhou (CN); Yang YANG, Hangzhou (CN)

(21) Appl. No.: 19/278,795

(22) Filed: Jul. 24, 2025

(30) Foreign Application Priority Data
Aug. 1, 2024 (CN) 202411054519.8
Aug. 1, 2024 (CN) 202411055314.1

(51) Int. Cl. H02M 3/335; H02M 1/08; H02M 1/36

(52) U.S. Cl. CPC H02M 3/33507; H02M 1/08; H02M 1/36

(57) ABSTRACT

The present disclosure proposes a switching power supply, comprising a power supply capacitor, for generating a power supply voltage to supply a control chip of the switching power supply with power, its first end being connected to the power supply terminal of the control chip of the switching power supply, its second end being grounded, and the first end generates a power supply voltage; a linear regulator circuit connected between the first end of the power supply capacitor and a common connection end of the main power transistor and the auxiliary power transistor; wherein, the voltage at the connection end between the main power transistor and the auxiliary power transistor charges the power supply capacitor through the linear voltage regulator The present disclosure can save power consumption, improve the working efficiency of switching power supply, and optimize the EMI of switching power supplies.

### CROSS-REFERENCE TO RELATED APPLICATIONS

This present disclosure claims priority to a Chinese patent application No. 202411054519.8, filed on Aug. 1, 2024, and entitled “switching power supply and control method thereof”, and further claims priority to a Chinese patent application No. 202411055314.1, filed on Aug. 1, 2024, and entitled “self-powered circuit for switching power supply and switching power supply”, the entire contents of which are incorporated herein by reference, including the specification, claims, drawings and abstract.

### FIELD OF TECHNOLOGY

The present disclosure relates to the field of power electronics, particularly to a switching power supply.

### BACKGROUND

By using normally-on power devices, it is convenient to achieve self-start and self-power supply. The self-start function can eliminate the need for additional resistance starting or high-voltage starting lines, and the self-power supply function can eliminate the need for auxiliary winding power supply.

As shown in FIG. 1, it is a self-powering circuit of a prior art switching power supply. Take a flyback converter as an example, the self-powering circuit comprises a main power transistor Q1 and an auxiliary power transistor Q2 connected in series, and the common connection terminal of the self-powering circuit and the power supply capacitor C0 are connected by a diode D1. The power supply capacitor C0 generates a power supply voltage VDD, which is used to power the control chip of the switching power supply. The power supply voltage VDD is obtained through an LDO (linear adjustment circuit) to obtain voltage VCC, which is used to power the driving circuit 01 of the auxiliary power transistor Q2. The driving circuit 01 receives a PWM signal to generate a driving signal DRV for controlling the on/off of the auxiliary power transistor Q2. The signal waveform diagram of the self-powering circuit is shown in FIG. 2. During the conduction period (t1˜t2) of the main power transistor Q1 and the auxiliary power transistor Q2, the excitation inductance of the flyback converter stores energy, the inductance current I_Lm increases, the voltage Vsw at SW and the voltage drop Vds_Q2 at the two ends of the auxiliary power transistor Q2 are at a low level, and the control chip is powered by the supply voltage VDD, which decreases. During the shutdown period (t2˜t3) of the main power transistor Q1 and the auxiliary power transistor Q2, the excitation inductance current supplies the output with power, and the inductance current I2 Lm decreases. The voltage Vsw at the SW node is clamped to Vin+Nps*Vo, wherein Vin is the DC input voltage of the flyback converter, Vo is the output voltage, and Nps is the ratio of the primary and secondary turns of the transformer Nps=Np/Ns. At this time, the main power transistor Q1 operate in the linear region, capacitor C0 is charging. The voltage drop of the main power transistor Q1 is Vds_Q1=VSW−(−Vgs_th), wherein Vgs_th is the threshold voltage of the D-Mode power device. Due to voltage clamping at SW, the loss of the main power transistor Q1 is relatively large, with loss P=Vds_Q1×Ivdd, wherein Ivdd is the average current consumed by the chip.

When the main power transistor Q1 and the auxiliary power transistor Q2 are turned off, the supply voltage VDD comes from the voltage Vsw at SW, which is a high voltage. At this time, the main power transistor Q1 works in the linear region, similar to a high voltage LDO, which will cause large power loss and low system efficiency.

### SUMMARY OF THE DISCLOSURE

The objective of the present disclosure is to provide a highly efficient switching power supply, to solve the problem in the prior art that power supply consumption is great and EMI performance is poor.

The present disclosure further provides a switching power supply, comprising a main power transistor, an auxiliary power transistor, and an inductor; the inductor is connected to a first end of the main power transistor, and the auxiliary power transistor is connected between a second end of the main power transistor and a ground terminal, wherein comprising:
a power supply capacitor, with its first end being connected to the power supply terminal of the control chip of the switching power supply, its second end being grounded, and its first end generating a power supply voltage;
a linear regulator circuit, connected between the first end of the power supply capacitor and the common connection end of the main power transistor and the auxiliary power transistor;
wherein, the voltage at the common connection end between the main power transistor and the auxiliary power transistor charges the power supply capacitor through the linear regulator.

Optionally, the linear regulator circuit comprises a first linear regulator circuit and a second linear regulator circuit, and the first linear regulator circuit and the second linear regulator circuit are connected in parallel;
wherein during the start-up process of the switching power supply, the first linear regulator circuit is turned on and the power supply capacitor is charged; when the PWM signal generated by the control chip of the switching power supply is valid, the second linear regulator circuit is turned on and the power supply capacitor is charged.

Optionally, when the PWM signal is valid, after the main power transistor is turned on for a period of time, the second linear regulator circuit is turned on, and the auxiliary power transistor is turned off.

Optionally, when the PWM signal changes from invalid to valid, the second linear regulator circuit is turned on and the auxiliary power transistor is turned off.

Optionally, when the supply voltage reaches a first threshold, the first linear regulator circuit is turned off.

Optionally, when the supply voltage reaches a second threshold, the second linear regulator circuit is turned off and the auxiliary power transistor is turned on.

Optionally, when the conduction time of the second linear regulator circuit reaches the set time, the second linear regulator circuit is turned off and the auxiliary power transistor is turned on.

Optionally, the second linear regulator circuit comprises a second switching transistor and a second diode, the second switching transistor and the second diode are connected in series, the anode of the second diode is connected to the common connection terminal of the auxiliary power transistor and the main power transistor, and its cathode is connected to the first end of the power supply capacitor;
further comprising a fourth transistor, wherein the first end of the fourth transistor is connected to the control end of the second switching transistor, and the second end of the fourth transistor is grounded;
when the PWM signal is valid, the fourth switching transistor is turned off.

Optionally, it further comprises a first module, connected between the first node and the control end of the auxiliary power transistor, and the common connection end of the inductor and the main power transistor is the first node;

wherein, the change rate of the voltage at the first node is adjusted by the first module to make the change rate of the voltage at the first node reach the expected change rate, and the charging current of the power supply capacitor is within the expected range.

Optionally, the first module adjusts the charging current of the power supply capacitor by adjusting the current flowing through the auxiliary power transistor.

Optionally, the current flowing through the first module is adjusted by adjusting the driving current of the auxiliary power transistor.

Optionally, the change rate of the voltage at the first node is adjusted by adjusting the change rate of the voltage of first module or the current flowing through the first module.

Optionally, the first module comprises a first module connected between the first node and the control end of the auxiliary power transistor;
wherein, by adjusting the change rate of the voltage of the first module, the change rate of the voltage of the first node can be adjusted.

Optionally, the first module comprises, a sampling circuit, connected to the first node, and used to sample the change rate of the voltage at the first node to obtain a sampling signal representing the change rate;
a controlled current source, connected between the first node and the control end of the auxiliary power transistor, and the sampling signal adjusts the output current of the controlled current source to adjust the current of the first module.

Optionally, the first module comprises a capacitor or a combination of series-parallel connection of multiple capacitors.

Optionally, the current flowing through the first module is adjusted to regulate the change rate of the voltage across the first module.

Optionally, given fixed current flows through the first module, the capacitance value of the first module is adjusted to regulate the change rate of the voltage at the first module.

Optionally, it comprises a driving circuit connected to the control terminal of the auxiliary power transistor, wherein the driving circuit receives a PWM signal and outputs a driving current, and the PWM signal is used to drive the auxiliary power transistor to turn on and off;

regulating the current flowing through the first module by adjusting the driving current.

The above-mentioned switching power supply, wherein the main power transistor is a depletion mode transistor.

Compared with the prior art, the present disclosure has the following advantages: the present disclosure charges the power supply capacitor of the system through the inductance current of the power circuit, greatly saving power consumption and improving system efficiency. Moreover, compared with the conventional auxiliary winding power supply schemes, it saves auxiliary windings and rectifier diodes. Meanwhile, due to the installation of the first linear regulator circuit, the charging circuit is always in standby mode, and the capacity of the power supply capacitor can be small, and only high-frequency switch ripple needs to be filtered. When the load is light or dynamic, the charging circuit where the first linear regulator circuit is located can automatically switch back, achieving the function of maintaining the power supply voltage. The present disclosure also introduces a first module, which is connected between the first node (the common connection end of the inductance and the main power transistor) and the control end of the auxiliary power transistor. By adjusting the change rate of the voltage of the first module or the current flowing through the first module, the change rate of the voltage of the first node can be adjusted, so as to optimize the EMI performance of the system; there are many ways to adjust the change rate of the voltage of the first module, which is simple; in addition, the first module introduced can be combined with the power supply circuit without affecting the power supply effect and EMI performance of the system.

### BRIEF DESCRIPTION OF THE DRAWINGS

FIG. 1 is a principle diagram of the self-powering circuit of the prior art

FIG. 2 is a working waveform of the prior art self-powering circuit;

FIG. 3 is a principle diagram of embodiment 1 of the switching power supply of the present disclosure;

FIG. 4 is a working waveform of embodiment 1 of the switching power supply of the present disclosure;

FIG. 5 is a driving signal waveform of embodiment 1 of the switching power

FIG. 6 is a working flow diagram of embodiment 1 of the switching power supply of the present disclosure;

FIG. 7 is a principle diagram of embodiment 2 of the switching power supply of the present disclosure;

FIG. 8 is a principle diagram of embodiment 1 of the first module in FIG. 7 of the present disclosure;

FIG. 9 is a principle diagram of embodiment 2 of the first module in FIG. 7;

FIG. 10 is a principle diagram of embodiment 3 of the first module in FIG. 7 of the present disclosure;

FIG. 11 is a waveform of embodiment 2 of the switching power supply of the present disclosure under the DCM working mode.

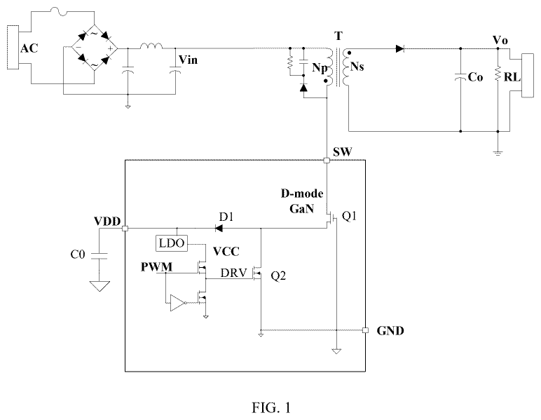

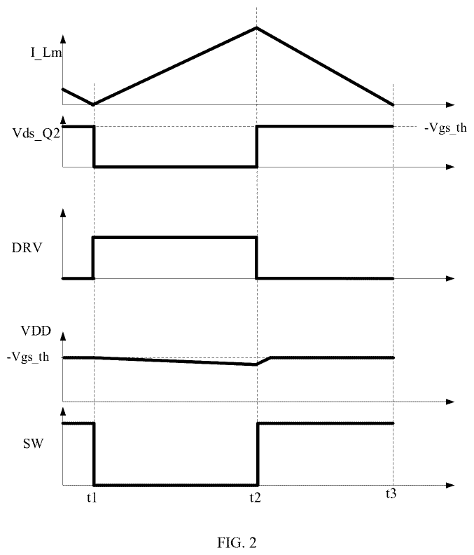

### DETAILED DESCRIPTION OF THE DISCLOSURE

The preferred embodiments of the present disclosure are described in detail below in conjunction with the accompanying drawings, but the present disclosure is not limited to these embodiments. The present disclosure covers any replacement, modification, equivalent method, and solution within the spirit and scope of the present disclosure.

In order to enable the public to have a thorough understanding of the present disclosure, specific details are described in detail in the following preferred embodiments of the present disclosure, and those skilled in the art can fully understand the present disclosure without the description of these details.

In the following paragraphs, the present disclosure is described more specifically by way of example and referring to the accompanying drawings. It should be noted that the accompanying drawings are in a simplified form and use imprecise proportions to facilitate and clarify the purpose of the embodiments of the present disclosure.

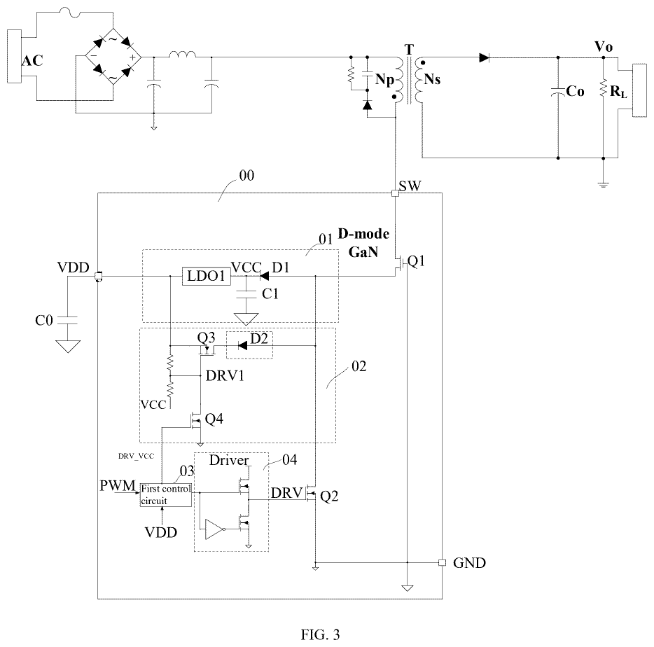

As shown in FIG. 3, it shows a principle diagram of embodiment 1 of the switching power supply of the present disclosure. In this embodiment, the switching power supply is illustrated by using a flyback converter as an example. However, in the present disclosure, the switching power supply is not limited to the flyback converter and can also be a buck converter, a boost converter, etc. In this embodiment, the flyback converter rectifies the AC input voltage to obtain a DC input voltage Vin. The main power transistor Q1 and the primary winding Np of the transformer T are connected in series, with the connection node being the switch node SW. The rectifier transistor DO and the secondary winding Ns of the transformer T are connected in series. By controlling the switching state of the main power transistor Q1, the DC input voltage Vin is converted into the output voltage Vo through the transformer T. Embodiment 1 of the switching power supply of the present disclosure comprises a power supply capacitor C0, a first linear regulator circuit 01, a second linear regulator circuit 02, an auxiliary power transistor Q2, a first control circuit 03, and a drive circuit 04. The main power transistor Q1 and the auxiliary power transistor Q2 of the flyback converter are connected in series, and the first linear regulator circuit 01 is connected between the common connection terminal of the main power transistor Q1 and the auxiliary power transistor Q2 and the first end of the power supply capacitor C0. The second end of the power supply capacitor C0 is grounded, and the second linear regulator circuit 02 and the first linear regulator circuit 01 are connected in parallel; the first control circuit 03 is used to control the on/off of the first linear regulator circuit 01 and the auxiliary power transistor Q2 according to the PWM signal. The driving circuit 04 receives the first control signal VC1 output by the first control circuit 03, and its output terminal is connected to the control terminal of the auxiliary power transistor Q2, which is used to drive the on/off of the auxiliary power transistor Q2. In the present disclosure, the main power transistor Q1 is a depletion mode transistor, preferably a depletion mode gallium nitride transistor, which is a high-voltage transistor.

When the switching power supply is just started, during the start-up process, the first linear regulator circuit 01 is turned on, and the DC input voltage Vin charges the power supply capacitor C0 through the transformer primary winding Np, the main power transistor Q1, and the first linear regulator circuit 01. The excitation inductor stores energy, and the power supply voltage VDD generated on the power supply capacitor C0 starts to rise from zero. When the power supply voltage VDD rises to the first threshold VDD1 (greater than or equal to the starting voltage of the chip), the first linear regulator circuit 01 is turned off, and the power supply voltage VDD can enable the control chip to work normally, that is, the switching power supply can work normally; after the control chip works normally, a PWM signal is generated, and the first voltage regulator circuit 01 is set to provide a starting voltage for the control chip, ensuring that the power supply voltage VDD is not lower than VDD1, to ensure that the control chip can start normally.

When the PWM signal is valid, the second linear regulator circuit 02 is turned on, the first linear regulator circuit 01 is turned off, the auxiliary power transistor Q2 is turned off, and the DC input voltage Vin continues to charge the power supply capacitor C0 through the transformer primary winding Np, the main power transistor Q1, and the second linear regulator circuit 02. The excitation inductor continues to store energy, and the power supply voltage VDD generated on the power supply capacitor C0 continues to rise; in one way, when the power supply voltage VDD reaches the second threshold VDD2, the second linear regulator circuit 02 is turned off and the auxiliary power transistor Q2 is turned on. In another way, when the conduction time of the second linear regulator circuit reaches the set time, the second linear regulator circuit 02 is turned off and the auxiliary power transistor Q2 is turned on. In either way, the purpose is to ensure that the supply voltage VDD is sufficient to supply the control chip of the switching power supply with power, and the supply voltage VDD not to be high, which affects the power supply efficiency; after the auxiliary power transistor Q2 is turned on, the DC input voltage Vin is completely supplied to the excitation inductor for energy storage through the main power transistor Q1 and the auxiliary power transistor Q2. When the PWM signal is invalid, the rectifier transistor DO on the secondary side is turned on, and the energy stored in the excitation inductor is released to the load. Both the main power transistor Q1 and the auxiliary power transistor Q2 are turned off.

The first linear regulator circuit 01 comprises a diode D1, a first capacitor C1, and an LDO1 (linear regulator unit). When the switching power supply is just started, the diode D1 and LDO1 are turned on, the first capacitor C1 charges, and an auxiliary supply voltage VCC is generated on the first capacitor C1. The voltage VCC charges the capacitor C0 through LDO1 to obtain the supply voltage VDD. When the supply voltage VDD reaches the first threshold VDD1, the second linear regulator circuit 02 is turned on.

The second linear regulator circuit 02 comprises a diode D2, a switching transistor Q3, and a switching transistor Q4. The diode D2 and the switching transistor Q3 are connected in series, and the anode of the diode D1 is connected to the common connection terminal of the main power transistor Q1 and the auxiliary power transistor Q2. The cathode of the diode D1 is connected to the first end of the power supply capacitor C0; the first end of transistor Q4 is connected to the control end of transistor Q3, and the second end of transistor Q4 is grounded. The control end of transistor Q3 and the first end of transistor Q4 also receive a driving voltage DRV1; the transistor Q3 adopts NMOS transistor. Before the transistor Q3 is turned on, the voltage VCC is approximately equal to the threshold voltage −Vgs_th of the transistor Q1, which is greater than the voltage VDD (the source voltage of the transistor Q3) and can effectively drive the transistor Q3 to turn on.

When the PWM signal is effective, the first control circuit 03 controls the transistor Q4 to turn off, and the auxiliary power transistor Q2 to turn off; according to the driving voltage DRV1 generated by the auxiliary power supply voltage VCC, the transistor Q3 is controlled to turn on. The DC input voltage Vin charges the power supply capacitor C0 through the diode D2 and the switching transistor Q3. When the power supply voltage VDD reaches the second threshold VDD2, the first control circuit 03 controls the switching transistor Q4 to turn on, causing the control terminal of the transistor Q3 to be pulled down to ground. The transistor Q3 is turned off, that is, the second linear regulator circuit 02 is turned off. At the same time, the first control circuit 03 also controls the auxiliary power transistor Q2 to turn on through the driving circuit 04. In the present disclosure, the system power supply capacitor C0 is charged by using the excitation inductance current of the power circuit of the flyback converter; compared with the existing high-voltage linear power supply scheme, it greatly saves power consumption and improves system efficiency. Compared with the conventional auxiliary winding power supply schemes, the present disclosure saves auxiliary windings and rectifier diodes, reducing power supply costs and volume; due to the fact that the first linear regulator circuit 01 is always in standby mode, the capacity of the power supply capacitor C0 can be relatively small. The power supply capacitor C0 only needs to filter the high-frequency switching ripple. When the switching power supply is lightly loaded or dynamic, the main power transistor Q1 is turned off for a long time, so that the power supply voltage VDD is sufficient to maintain the normal operation of the control chip. The first linear regulator circuit 01 can be turned on automatically, and as a charging circuit, it can automatically switch back, achieving the function of maintaining the power supply voltage VDD all the time.

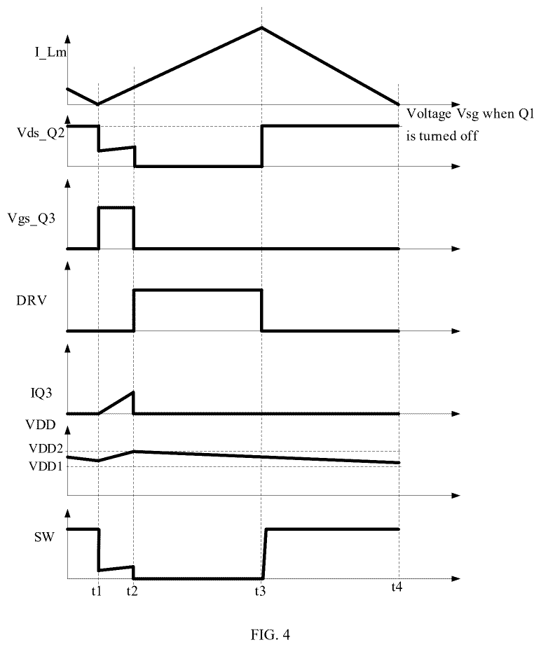

As shown in FIG. 4, it shows a working waveform diagram of embodiment 1 of the switching power supply of the present disclosure. The waveform diagram is the waveform diagram of the switching power supply system when it is stable. During a period of time after the main power transistor Q1 is turned on, that is, t1˜t2, the gate source voltage Vgs_Q3 of the switching transistor Q3 is a high-level signal. The switching transistor Q3 is turned on, and the DC input voltage Vin charges the power supply capacitor C0 and stores energy in the excitation inductor through the main power transistor Q1 and the switching transistor Q3, and the charging current IQ3 flowing through the switching transistor Q3 and the inductor current I_Lm gradually increase, the power supply voltage VDD on the charging capacitor C0 gradually increases, and the voltage Vsw at the switching node SW decreases, and the voltage drop Vds_Q2 at both ends of the auxiliary power transistor Q2 decreases. When the supply voltage VDD reaches the second threshold VDD2 (time t2), the transistor Q3 is turned off, and the gate source voltage Vgs_Q3 of the transistor Q3 becomes a low-level signal; at t2˜t3, the driving signal DRV of the auxiliary power transistor Q2 is a high-level signal, which drives the auxiliary power transistor Q2 to turn on. The DC input voltage Vin completely stores energy in the excitation inductor through the main power transistor Q1 and the auxiliary power transistor Q2, and the power supply voltage VDD supplies the chip with power, and gradually decreases, and the auxiliary power transistor Q2 is fully turned on, and the voltage drop Vds is minimized, the voltage Vds drops to the lowest, and the voltage Vsw at the switch node SW is minimized; at t2˜t3, the main power transistor Q1, auxiliary power transistor Q2, and transistor Q3 are all turned off, and the energy stored in the excitation inductance is released to the output terminal.

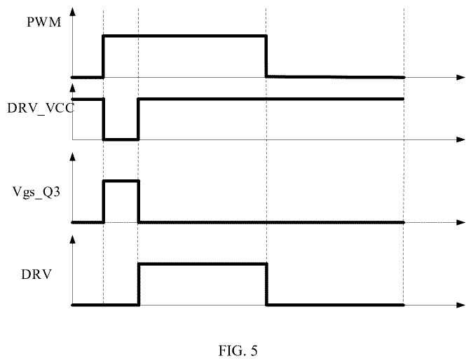

As shown in FIG. 5, it shows a driving signal waveform diagram of embodiment 1 of the switching power supply of the present disclosure. Corresponding to the working waveform diagram of FIG. 4, the PWM signal controls the on/off of the main power transistor Q1. The PWM signal is effective when it is at a high level and ineffective when it is at a high level. During period t1-t3, the PWM signal is active at a high level, the main power transistor Q1 is turned on, the excitation inductor stores energy, and i_Lm rises; at period t1-t2, during the effective PWM signal period (t1-t3), the low level of the driving voltage DRV_VCC of transistor Q4 is invalid, transistor Q4 is turned off, the high level of the driving voltage Vgs_Q3 of transistor Q3 is valid, transistor Q3 is turned on, and the DC input voltage Vin charges the supply capacitor C0 through the main power transistor Q1 and transistor Q3, causing the supply voltage VDD to rise; at time t2, the supply voltage VDD reaches the second threshold VDD2. During period t2-t3, the high level of DRV_VCC is invalid, driving the transistor Q4 to turn on, the driving voltage Vgs_Q3 of the transistor Q3 is pulled down to ground potential, and the transistor Q3 is turned off, and the driving voltage DRV of the auxiliary power transistor Q2 is high and effective, and the auxiliary power transistor Q2 is turned on, and the DC input voltage Vin completely stores energy in the excitation inductance through the main power transistor Q1 and the auxiliary power transistor Q2; during the time period t3-t4, PWM low level is invalid, DRV_VCC remains at high level, transistor Q4 is conductive, Vgs_Q3 continues to be pulled down, transistor Q3 continues to be turned off, DRV is invalid at low level, auxiliary power transistor Q2 is turned off, and the excitation inductor releases energy to the output load and output capacitor of the switching power supply. In the present disclosure, time period t1-t2 is not limited, as long as the charging of the power supply capacitor C0 is completed during the effective period of the PWM high level, so that the power supply voltage VDD can reach the second threshold VDD2, that is, the present disclosure can also control the transistor Q3 to turn on and the auxiliary power transistor Q2 to turn off after the PWM signal switches from low level to high level for a period of time. When the power supply capacitor C0 is charged and the power supply voltage VDD reaches the second threshold VDD2, the switch Q3 can be controlled to turn off and the auxiliary power transistor Q2 can be controlled to turn on.

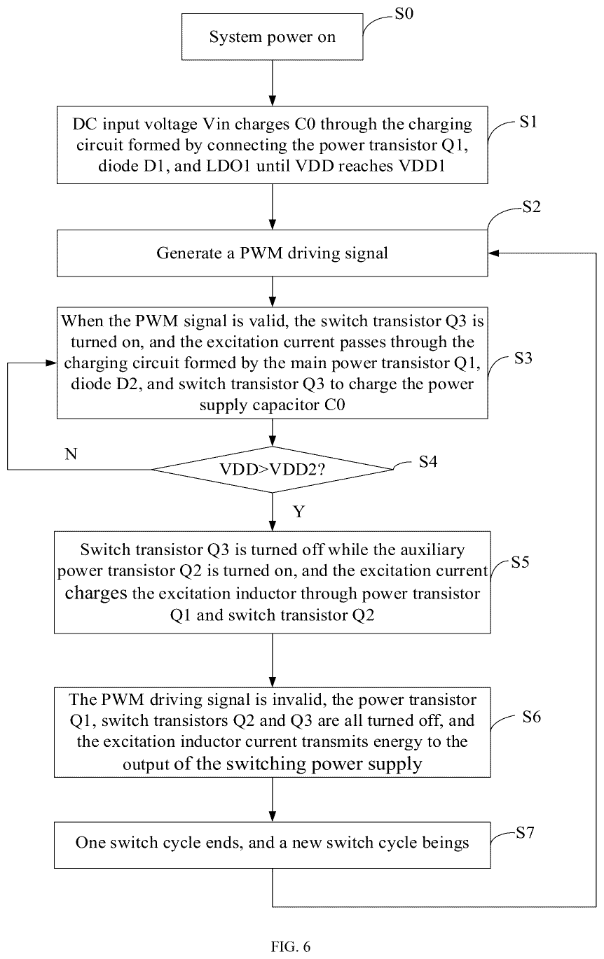

As shown in FIG. 6, it shows a workflow diagram of embodiment 1 of the switching power supply of the present disclosure, including steps S0, S1, . . . , S6, S7; at step S0, system is powered on; at step S1, the DC input voltage Vin charges the power supply capacitor C0 through a charging circuit formed by the main power transistor Q1, diode D1, and LDO1, until the power supply voltage VDD reaches the first threshold VDD1; at step S2, the control chip is powered on to generate a PWM signal; at step S3, the PWM signal is valid, the transistor Q3 is turned on, and the excitation current passes through the charging circuit formed by the main power transistor Q1, diode D2, and transistor Q3 to charge the power supply capacitor C0; at step S4, determine whether the supply voltage VDD is greater than the second threshold VDD2 (or whether the conduction time of the second linear regulator circuit has reached the set time). If so, proceed to step S5; otherwise, return to step S3; at S5, transistor Q3 is turned off, and the auxiliary power transistor Q2 is turned on, and the excitation current charges the excitation inductor through the power circuit where the main power transistor Q1 and auxiliary power transistor Q2 are located; at S6, the PWM signal is invalid, the main power transistor Q1, auxiliary power transistor Q2, and transistor Q3 are all turned off, and the excitation inductor current transfers energy to the output of the switching power supply; at S7, after one switching cycle ends and a new switching cycle begins, return to step S2 and repeat the above steps.

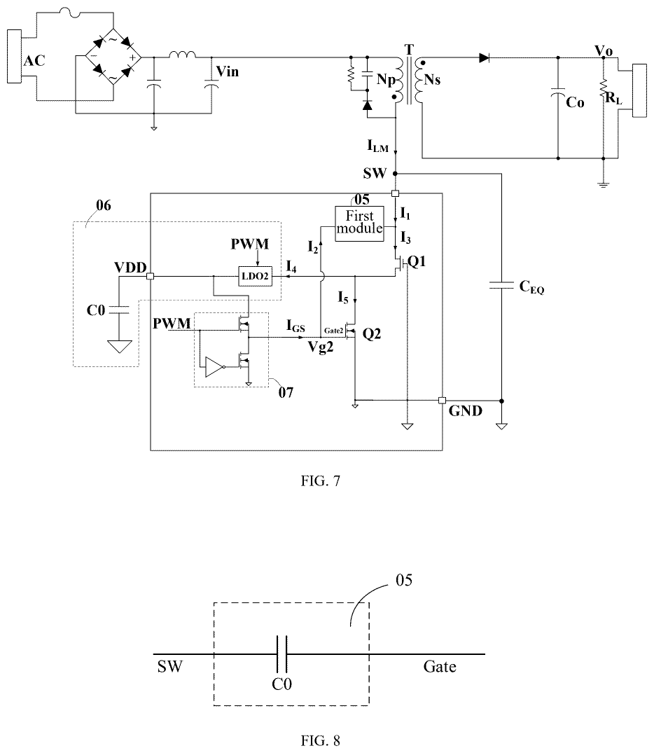

As shown in FIG. 7, the working principle diagram of embodiment 2 of the switching power supply of the present disclosure is illustrated. The switching power supply is illustrated using a flyback converter as an example, but in the present disclosure, the switching power supply is not limited to a flyback converter and can also be a buck converter, a boost converter, etc. In this embodiment, the flyback converter rectifies the AC input voltage AC to obtain a DC input voltage Vin. The main power transistor Q1 and the primary winding Np of the transformer T are connected in series, with the connection node being the first node SW. The rectifier transistor DO and the secondary winding Ns of the transformer T are connected in series. By controlling the switching state of the main power transistor Q1, the DC input voltage Vin is converted into the output voltage Vo through the transformer T. The main power transistor Q1 of the present disclosure is a depletion mode transistor, preferably a depletion mode gallium nitride transistor, with the gate of the main power transistor Q1 grounded; there is parasitic capacitance between the gate and drain of the main power transistor Q1, and the primary winding of transformer T also has parasitic capacitance. The connection path between the main power transistor Q1 and the primary winding of transformer T also has parasitic capacitance. These parasitic capacitances in the flyback converter are equivalent to the equivalent capacitance CEQ in the figure. The flyback converter also comprises an auxiliary power transistor Q2 connected to the main power transistor Q1 and a driving circuit 07. The driving circuit 07 receives PWM signals to control the on/off of the auxiliary power transistor Q2; when PWM changes from being ineffective to effective, it generates a pull-up driving current IGS, which in turn generates a high-level driving voltage, controls the auxiliary power transistor Q2 to turn on, or after a short delay when the PWM signal changes from ineffective to effective, controls the auxiliary power transistor Q2 to turn on. In short, the auxiliary power transistor Q2 is turned on during the effective period of PWM. When the PWM signal changes from effective to ineffective, it generates a pull-down driving current IGS, which in turn generates a low-level driving voltage, and controls the auxiliary power transistor Q2 to turn off. The flyback converter also includes a self-powered unit, and the self-powered unit 06 comprises LDO2 (linear regulator circuit) and a power supply capacitor C0; the first end of LDO2 is connected to the common connection terminal of the main power transistor Q1 and the auxiliary power transistor Q2, and the second end of LDO2 is connected to the first end of the power supply capacitor C0, and the second end of the power supply capacitor C0 is grounded, and the power supply voltage VDD is generated on the power supply capacitor C0 to supply power to the driving circuit 07. The power supply capacitor C0 is usually integrated outside the control chip, and the main power transistor Q1, auxiliary power transistor Q2, and LDO2 are integrated inside the chip. Optionally, the LDO2 in this embodiment may comprise the first voltage regulator circuit 01 and the second voltage regulator circuit 02 shown in FIG. 3.

The switching power supply of the disclosure further comprises a first module 05, which is connected between the first node and the control end of the auxiliary power transistor Q2. Since one end of the first module 05 is connected to the first node SW, the disclosure is designed to adjust the change rate of the voltage on the first module 05 or adjust the current I2 flowing through the first module to adjust the change rate of the first node voltage Vsw to achieve the expected change rate, so as to optimize the EMI of the system. The change rate of the first node voltage is related to the change rate of the voltage on the first module 05 or the current I2 flowing through the first module 05, preferably positive correlation, here positive correlation means that the absolute value of the change rate of the first node voltage is positively related to the absolute value of the change rate of the voltage on the first module 05 or the absolute value of the current I2 flowing through the first module.

When the switching power supply has a self-power supply unit 06 as shown in the disclosure, while the change rate of the first node is adjusted through the first module 05, the power supply loss of the self-power supply unit 06 can be optimized through the first module 05 to improve the power supply efficiency. Specifically, if the current I4 (I4 is less than or equal to I2) flowing through LDO2 is set, the change rate of the first node voltage Vsw is large, and the current I3 of the main power transistor Q1 is large, it is necessary to reduce the change rate of the first node voltage Vsw, and adjust the current I2 flowing through the first module 05 to reduce, that is, the current drawn out by the gate of the auxiliary power transistor Q2 decreases, so that the gate drive voltage Vg2 of the auxiliary power transistor increases, and then adjust the current I5 flowing through the auxiliary power transistor Q2 to increase; however, current I4 flowing through LDO2 is equal to the set current, so that the sum of I4 and I5 currents is always equal to I3. According to the above analysis, the current I5 flowing through the auxiliary power transistor Q2 can be automatically adjusted through the first module 05, so that the current I4 flowing through LDO2 is just the charging current of the power supply capacitance, without energy waste. The first module 05 optimizes the charging energy of the power supply capacitance C0 while optimizing the system EMI.

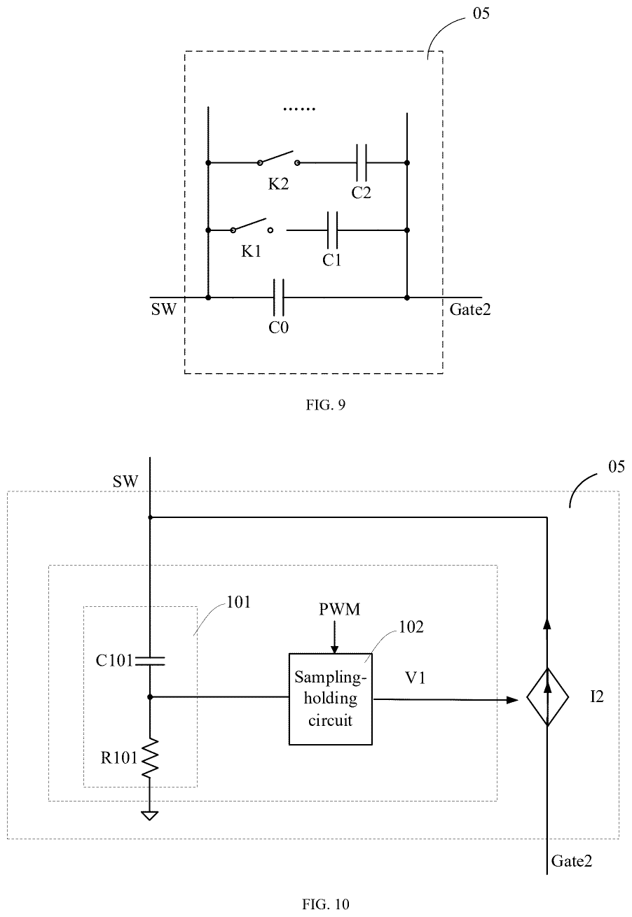

FIGS. 8 and 9 show the schematics diagram of Embodiment 1 and Embodiment 2 of the first module of the present disclosure. The first module in FIG. 7 comprises a first module, which comprises a capacitor or a combination of series-parallel connection of several capacitors. Specifically, as shown in FIG. 8, first module 05 comprises a capacitor C0, which is connected between the first node SW and the gate control terminal of auxiliary power transistor Q2. Since the driving voltage of the gate of auxiliary power transistor Q2 is much lower than the voltage Vsw of the first node, the voltage Vsw of the first node can be equivalent to the voltage across capacitor 01, thus equation (1):

$$I 2 = C 0 \times \frac{dVsw}{dt} ,$$

wherein, I2 is the current flowing through capacitor C0 (the current direction is from the gate of auxiliary power transistor Q2 Gate2 to the first node SW), and Vsw is the voltage of the first node. From equation (1), it can be seen that when the capacitance value of capacitor C0 is fixed, the change rate of the first node voltage Vsw can be adjusted by adjusting the current I2 flowing through capacitor C0. By adjusting the change rate to the ideal change rate, the EMI of the system can be optimized. Preferably, the larger the current I2 flowing through capacitor C0, the greater the change rate of the first node voltage Vsw, and I2 is directly proportional to this change rate.

Furthermore, due to the connection between capacitor C0 and the control terminal of auxiliary power transistor Q2, the current I2 flowing through capacitor C0 and the driving current IGS generated by driving circuit 07 jointly determine the Miller platform voltage of auxiliary power transistor Q2, thereby determining the descending slope of the first node voltage Vsw. Therefore, by adjusting the driving current IGS, the current I2 flowing through capacitor 01 can be adjusted, thereby adjusting the change rate of the first node voltage Vsw and optimizing the system EMI; in addition, adjusting the current I2 flowing through capacitor 01 can also adjust the current I5 flowing through auxiliary power transistor Q2, thereby optimizing the system power supply.

Furthermore, when a fixed current flows through the first module, the capacitance value of the first module can be adjusted by adjusting the number of parallel/series capacitors, thereby adjusting the change rate of the first node voltage Vsw and optimizing the system EMI.

As shown in FIG. 9, first module 05 comprises multiple capacitors. Take three capacitors as an example in the drawing, capacitor C0 is connected between the first node SW and the auxiliary power transistor Q2. Capacitor C1 is connected in series with switch K1 and then they are connected in parallel with capacitor C0, capacitor C2 is connected in series with switch K2 and then they are connected in parallel with capacitor C0. Capacitor C0 can be a basic capacitor with a smaller capacitance value in first module 05. In this embodiment, given a fixed current flowing through the first module, the capacitance value in first module 05 is adjusted by adjusting the number of capacitors connected in parallel, thereby adjusting the change rate of the first node voltage Vsw. For example, when it is necessary to reduce the change rate of the first node voltage Vsw, and the capacitance value of the first module 05 needs to be increased, the number of capacitors connection with capacitor C0 should be increased; when it is necessary to increase the change rate of the first node voltage Vsw, and the capacitance value of the first module 05 needs to be decrease by reducing the number of capacitors connected in parallel with capacitor C0. The capacitance value of first module 05 here refers to the total capacitance value of all capacitors that can flow current in parallel. Furthermore, the first module can also include multiple capacitors connected in series(not shown in the figure). Given a fixed current flowing through the first module, the change rate of the first node voltage Vsw can be adjusted by adjusting the number of capacitors connected in series in the first module, thereby optimizing the system EMI.

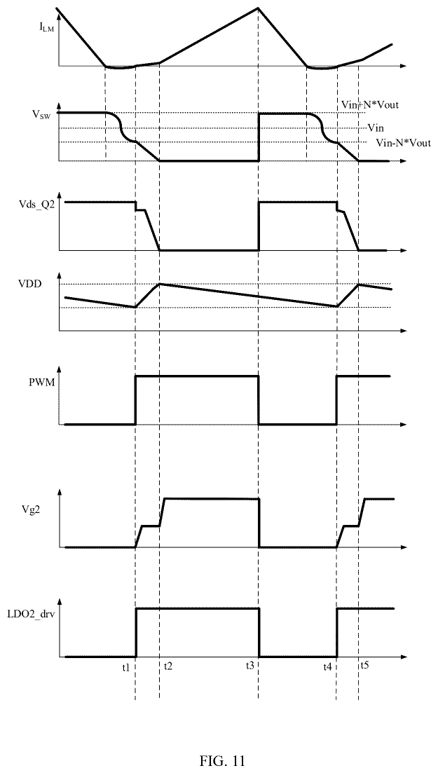

As shown in FIG. 10, it shows a principle diagram of Embodiment 3 of the first module of the disclosure. Refer to the above description of FIG. 8, in this embodiment, the output current of the controlled current source I2 can be equivalent to the current flowing through the first module, that is, the controlled current source I2 is equivalent to the capacitance model. Therefore, the output current of the controlled current source I2 is designed to be related to the change rate of the voltage at the first node, and then the size of the output current of the controlled current source can be controlled according to the change rate of voltage at the the first node to adjust the change rate of the voltage at the first node. Specifically, the first module 05 comprises a sampling circuit 101, a sampling-holding circuit 102 and a controlled current source I2. The sampling circuit 101 comprises a resistor R101 and a capacitor C101 connected in series. The first end of the capacitance C101 is connected to the first node SW, the second end of the capacitance C101 is connected to the first end of the resistance R101, and the second end of the resistance R101 is grounded; the voltage at the common connection end of resistor R101 and capacitor C101 can characterize the change rate of the voltage Vsw at the first node. The input terminal of the sampling-holding circuit 102 is connected to the common connection end of resistor R101 and capacitor C101. When the PWM signal is valid, the voltage at the common connection end of resistor R101 and capacitor C101 is sampled and held to obtain the sampling signal V1; the control terminal of the controlled current source I2 receives the sampling signal V1, which controls the magnitude of the output current of the controlled current source I2, the direction of the output current of the controlled current source I2 is from the gate of the auxiliary power transistor Q2. Furthermore, the larger the change rate of the first node voltage, the smaller the output current of the controlled current source I2. For example, if the change rate of the first node voltage Vsw is large and the current flowing through the main power transistor Q1 is large, the output current of the controlled current source I2 will be reduced, thereby reducing the change rate of the first node voltage Vsw to achieve the expected change rate; meanwhile, due to the decrease in current drawn from the gate of auxiliary power transistor Q2, the gate driving voltage of auxiliary power transistor Q2 is increased, thereby increasing the current I5 flowing through auxiliary power transistor Q2, while ensuring that the current flowing through LDO2 is always maintained at the expected set current. This embodiment can optimize the EMI and power supply efficiency of the system by detecting the change rate of the first node voltage to adjust the current flowing through the first module.

As shown in FIG. 11, it shows a working waveform of the switching power supply of the present disclosure in the DCM mode, wherein ILM is the excitation inductance current waveform of the flyback converter, Vsw is the voltage waveform of the first node, Vds_Q2 is the leakage source voltage waveform of the auxiliary power transistor Q2, VDD is the supply voltage waveform, PWM is the pulse width modulation signal obtained by the switching power supply, Vg2 is the gate voltage waveform of the auxiliary power transistor, and LDO_2drv is the driving signal for controlling the on/off of LDO2. At time t1, when the PWM signal changes from low level invalid to high level valid, the auxiliary power transistor Q2 is turned on, LDO2 is also turned on, and the drain source voltage Vds_Q2 of auxiliary power transistor Q2 decreases; during the t1-t2 time period, which is the conductive process of the auxiliary power transistor Q2, i.e., partially conductive stage, the gate voltage Vg2 of the auxiliary power transistor Q2 gradually rises to reach the Miller flat voltage until the Miller platform stage ends. The first node voltage Vsw charges the power supply capacitor through the normally open main power transistor Q1 and LDO2, and the power supply voltage VDD starts to rise. The first node voltage Vsw decreases, the excitation inductor charges, and the excitation inductor current ILM increases; at time t2, the auxiliary power transistor Q2 is fully turned on, and the drain voltage of auxiliary power transistor Q2 drops to a low level, the first node voltage Vsw drops to a low level, LDO2 is short circuited and turned off, and the power supply capacitor stops charging, the supply voltage VDD stops rising; at time period t2-t3, as the auxiliary power transistor Q2 is fully turned on, the excitation inductance continues to charge, and the excitation inductance current ILM continues to rise. Since it supplies power to the control chip, the supply voltage VDD gradually decreases. In this working waveform, when the inductance circuit drops to the bottom; during the opening process of the auxiliary power transistor Q2, the power supply capacitor charges until the auxiliary power transistor Q2 is fully turned on. In another working waveform, the auxiliary power transistor Q2 is only turned on after a delay period when the PWM signal changes from invalid to valid, in this working waveform, the power supply capacitor can also start charging when the PWM signal changes from invalid to valid until the auxiliary power transistor Q2 is fully turned on. In the CCM working mode, the same power supply method can also be used. Therefore, during the turning-on process of the auxiliary power transistor, controlling the charging of the power supply capacitor can recover a portion of the opening loss, improve power supply efficiency, and avoid high losses caused by high voltage Vsw charging the power supply capacitor when the auxiliary power transistor is turned off.

The present disclosure not only optimizes the EMI performance of the switching power supply, but also reduces power supply losses and improves the power supply efficiency of the system on this basis.

Although the above embodiments have been explained and elaborated separately, some common technologies involved can be replaced and integrated between the embodiments in the eyes of those of ordinary skill in the art. If there is any content that is not clearly recorded in one embodiment, reference can be made to the other embodiment that is recorded

The above implementation methods do not constitute a limitation on the protection scope of the technical solution. Any modifications, equivalent substitutions, and improvements made within the spirit and principles of the above implementation shall be included within the protection scope of the technical solution.

What is claimed is:

1. A switching power supply, comprising a main power transistor, an auxiliary power transistor, and an inductor; the inductor being connected to a first end of the main power transistor, and the auxiliary power transistor being connected between a second end of the main power transistor and a ground terminal, wherein the switching power supply comprises:
a power supply capacitor, with a first end being connected to the power supply terminal of a control chip of the switching power supply, a second end being grounded, and a first end generating a power supply voltage;
a linear regulator circuit, connected between the first end of the power supply capacitor and a common connection end of the main power transistor and the auxiliary power transistor;
wherein, a voltage at the common connection end between the main power transistor and the auxiliary power transistor charges the power supply capacitor through the linear regulator circuit.

2. The switching power supply of claim 1, wherein the linear regulator circuit comprises a first linear regulator circuit and a second linear regulator circuit, and the first linear regulator circuit and the second linear regulator circuit are connected in parallel;
wherein during a start-up process of the switching power supply, the first linear regulator circuit is turned on and the power supply capacitor is charged; when a PWM signal generated by the control chip of the switching power supply is valid, the second linear regulator circuit is turned on and the power supply capacitor is charged.

3. The switching power supply of claim 2, wherein when the PWM signal is valid, after the main power transistor is turned on for a period of time, the second linear regulator circuit is turned on, and the auxiliary power transistor is turned off.

4. The switching power supply of claim 2, wherein when the PWM signal changes from invalid to valid, the second linear regulator circuit is turned on and the auxiliary power transistor is turned off.

5. The switching power supply of claim 2, wherein when the power supply voltage reaches a first threshold, the first linear regulator circuit is turned off.

6. The switching power supply of claim 2, wherein when the power supply voltage reaches a second threshold, the second linear regulator circuit is turned off and the auxiliary power transistor is turned on.

7. The switching power supply of claim 2, wherein when a conduction time of the second linear regulator circuit reaches a set time, the second linear regulator circuit is turned off and the auxiliary power transistor is turned on.

8. The switching power supply of claim 2, wherein the second linear regulator circuit comprises a second switching transistor and a second diode, wherein the second switching transistor and the second diode being connected in series, an anode of the second diode is connected to the common connection terminal of the auxiliary power transistor and the main power transistor, and a cathode of the second diode being connected to the first end of the power supply capacitor;
and further comprises a fourth transistor, wherein a first end of the fourth transistor is connected to the control end of the second switching transistor, and a second end of the fourth transistor is grounded;
when the PWM signal is valid, the fourth switching transistor is turned off.

9. The switching power supply of claim 1, further comprising a first module, connected between a first node and the control end of the auxiliary power transistor, and the common connection end of the inductor and the main power transistor being the first node;
wherein, a change rate of the voltage at the first node is adjusted by the first module, so that the change rate of the voltage at the first node reach an expected change rate, and a charging current of the power supply capacitor is within an expected range.

10. The switching power supply of claim 9, wherein the first module adjusts the charging current of the power supply capacitor by adjusting a current flowing through the auxiliary power transistor.

11. The switching power supply of claim 10, wherein the current flowing through the first module is adjusted by adjusting a driving current of the auxiliary power transistor.

12. The switching power supply of claim 9, wherein the change rate of the voltage at the first node is adjusted by adjusting the change rate of the voltage of the first module or the current flowing through the first module.

13. The switching power supply of claim 9, wherein the first module comprises a capacitor module connected between the first node and the control end of the auxiliary power transistor;
wherein, by adjusting the change rate of the voltage of the capacitor module, the change rate of the voltage of the first node is adjusted.

14. The switching power supply of claim 9, wherein the first module comprise;
a sampling circuit, connected to the first node, and used to sample the change rate of the voltage at the first node to obtain a sampling signal representing the change rate;
a controlled current source, connected between the first node and the control end of the auxiliary power transistor, wherein the sampling signal adjusts an output current of the controlled current source to adjust a current of the first module.

15. The switching power supply of claim 11, wherein the capacitor module comprises a capacitor or a combination of series-parallel connection of multiple capacitors.

16. The switching power supply of claim 13, wherein the current flowing through the first module is adjusted to regulate the change rate of the voltage across the first module.

17. The switching power supply of claim 13, wherein: a given consistant current flows through the first module, a capacitance value of the capacitor module is adjusted to regulate the change rate of the voltage of the first module.

18. The switching power supply of claim 11, further comprising a driving circuit connected to a control terminal of the auxiliary power transistor, wherein the driving circuit receives a PWM signal and outputs a driving current, and the PWM signal is used to drive the auxiliary power transistor to turn on and off;
the current flowing through the first module is regulated by adjusting the driving current.

19. The switching power supply of claim 1, wherein the main power transistor is a depletion mode transistor.
